(19) United States
(12) Patent Application Publication
(10) Pub. No.: US 2007/0080589 A1
(43) Pub. Date: Apr. 12, 2007

(54) Consolidated energy system generator

(76) Inventor: James Esturo, West Hempstead, NY (US)

Correspondence Address: WEISS & WEISS;Suite 251, 300 Old Country Road, Mineola, NY, 11501, US

(21) Appl. No.: 11/529,156

(22) Filed: Sep. 28, 2006

Related U.S. Application Data
(60) Provisional application No. 60/721,433, filed on Sep. 28, 2005.

(51) Int. Cl. H02N 3/00

(52) U.S. Cl. 310/10

(57) ABSTRACT

The present invention relates to a consolidated energy system generator.

### RELATED APPLICATIONS

The following application is based on U.S. Provisional Patent Application No. 60/721,433 filed Sep. 28, 2005.

### FIELD OF THE INVENTION

The present invention relates to consolidated energy system generator.

### BACKGROUND OF THE INVENTION

US Patent Publication No. 2004/0021390 relates to a rotary electric machine capable of improving the reliability of an object with the same, a permanent magnet type synchronous rotary electric machine comprises a stator with windings. A rotor arranged supported for rotation in the stator with a gap between the inner surface of the stator and the outer surface thereof, is divided into two rotor bodies each provided with permanent magnets of opposite polarities alternately arranged in a circumferential direction. In switching the permanent magnet type synchronous rotary electric machine from a motor to a generator, a second rotor body is moved axially relative to a first rotor body to an axial position that makes the intensity of a combined magnetic field created by the permanent magnets lower than that of a combined magnetic field created by the permanent magnets when the second rotor body is located at a predetermined position, and then the second rotor body is moved to the predetermined position.

US Patent Publication No. 2002/0157881 relates to a power generation system for a hybrid electric vehicle. The system includes a fuel source, a turbogenerator coupled to the fuel source, and a power controller. The power controller is electrically coupled to the turbogenerator, and includes first and second power converters. The first power converter converts AC power from the turbogenerator to DC power on a DC bus, and the second power converter converts the DC power on the DC bus to an operating DC power on output lines. The power controller regulates the fuel to the turbogenerator, independent of DC voltage on the DC bus. The system further includes an electric motor, a drive control unit coupled between the output lines and the electric motor, and a traction battery. The traction battery is coupled across the output lines, and provides an additional source of current, upon demand, to the electric motor.

US Patent Publication No. 2005/0061561 relates to a stabilized electric distribution system for use in a vehicle having electric assist. The system electrically couples an electric assist bus to an accessory load bus while protecting the first electrical bus from electric assist and regenerative braking induced voltage variations. An energy management controller selectively controls each of a electric motor/generator, a DC/DC converter, and an alternator to affect electric energy distribution within the system.

US Patent Publication No. 2005/0090365 relates to a method for controlling the fueling of a motor vehicle and for controlling the cut off of fueling of a hybrid electric motor vehicle during deceleration of that motor vehicle. In a hybrid electric motor vehicle having an internal combustion engine, a motor/generator, and a continuously variable transmission, the invention comprises the steps of sensing throttle position of the internal combustion engine and slewing the transmission to a higher gear ratio in response to sensing a closed throttle position. The method further comprises cutting fueling of the internal combustion engine during the deceleration, and coupling the motor/generator in parallel with the internal combustion engine with the motor/generator operating as a generator.

U.S. Pat. No. 3,992,885 relates to a drive arrangement for the auxiliary aggregates of a motor vehicle equipped with an internal combustion engine which includes an electrical power supply system with a generator and a battery; only those auxiliary aggregates which have a power requirement dependent on the rotational speeds are thereby driven from the internal combustion engine, whereas all auxiliary aggregates which have a power requirement independent of the rotational speed are driven in common from an electrical motor operating at substantially constant rotational speed and fed from the electrical power supply system; a thermionic converter operable by means of the field of the motor vehicle is thereby provided as generator.

U.S. Pat. No. 5,945,808 relates to a hybrid vehicle which comprises an electric motor, a battery pack for the electric motor, a generator driven by an engine to provide electric power for charging the battery pack, and a battery management for the battery pack. The battery management determines a current value of battery temperature of the battery pack and a current value of state of charge within the battery pack.

U.S. Pat. No. 6,275,004 relates to an apparatus for balancing a battery module in a vehicle including a plurality of batteries in the battery module, the plurality of batteries connected in series, the plurality of batteries each having a battery voltage, and at least one battery providing power to an electrical system of the vehicle, an electric generator producing a generator voltage to charge the plurality of batteries, and a DC-DC converter coupled to the electrical generator and receiving power from the electrical generator, the DC-DC converter monitoring at least one of the battery voltages of at least one of the plurality of batteries and controlling the battery voltage of the battery providing power to the electrical system of the vehicle with reference to the monitored battery voltage.

U.S. Pat. No. 6,645,017 relates to a marine powertrain which includes a flywheel motor generator (MG) directly driven by an engine to which a marine drive is also connected. The MG provides a 36 volt AC power output to charge a 36 volt battery to crank the engine for starting. The marine drive is connected to the engine output shaft through a hollow rotor of the MG.

U.S. Pat. No. 6,376,927 relates to a fuel management control method for a hybrid electric vehicle drive having an internal combustion engine and an electric motor arranged in parallel such that both can propel the vehicle; the system including an electric motor driven fuel pump and a programmable microprocessor. The electric motor provides regenerative braking or vehicle start during such fuel shut off modes of operation.

U.S. Pat. No. 6,209,672 relates to a hybrid vehicle comprising an internal combustion engine controllably coupled to road wheels of the vehicle by a clutch, a traction motor coupled to road wheels of the vehicle, a starting motor coupled to the engine, both motors being operable as generators, a battery bank for providing electrical energy to and accepting energy from the motors, and a microprocessor for controlling these components is operated in different modes, depending on its instantaneous torque requirements, the state of charge of the battery bank, and other operating parameters.

U.S. Pat. No. 6,595,307 relates to a hybrid vehicle including an internal combustion engine, an electric motor, a generator, a battery, and a catalytic converter disposed in an exhaust system of the engine. A determination is made as to whether a condition for stopping the engine is established based on the operating state of the vehicle. Then, the fuel supply to the engine is cut off when the condition for stopping the engine is established, and a load is applied to the engine so as to restrict rotation of the engine.

U.S. Pat. No. 5,214,358 relates to a motor vehicle which includes an electrochemical transmission system having an engine driven generator and a motor adapted to drive one or more wheels of the vehicle, the generator connected to the motor via a DC to DC converter by which the current output of the generator may be varied to provide appropriate current input to the motor and a control unit including a transducer to sense the performance of the vehicle and a speed control device for operation by the driver. The control unit is arranged to control the engine and the DC to DC converter to optimize operation of the transmission to match the requirements of the driver to the performance of the vehicle.

US patent publication No. 2002/0049115 relates to a hybrid vehicle including an internal combustion engine, an electric motor, a generator, a battery, and a catalytic converter disposed in an exhaust system of the engine, a determination is made as to whether a condition for stopping the engine is established, based on an operating state of the vehicle. Then, the fuel supply to the engine is cut off when the condition for stopping the engine is established, and a load is applied to the engine so as to restrict rotation of the engine.

U.S. Pat. No. 6,327,994 relates to a wideface energy converter device, in the form of a wideface solar heat receiver or a wideface fluid impeder device. The wider is the solar heat receiver, the more solar power is available for conversion.

### SUMMARY OF THE INVENTION

The present invention relates to a consolidated energy system generator. The system comprises an electrical motor, a battery, generator, charging system, and an AC/DC converter or inverter.

It is an object of the present invention for the battery power to travel into an AC/DC converter or inverter depending on the power requirements for the electric motor. It is an object of the present invention for the power converter or inverter to produce 110 or 220 volts for the electric motor.

It is an object of the present invention for the motor and generator to be belt driven with a variable speed pulley.

It is an object of the present invention for the electric motor to be on a motor plate, which pivots up or down. It is an object of the present invention for either a voltage sensor or small on-board computer to be attached to a small micro-motor that drives the worm gear. It is an object of the present invention for the worm gear to be attached to the motor plate to help pivot the motor plate up or down which will help control RPM's of the motor generator.

It is an object of the present invention for the motor to have a variable speed pulley that assists in controlling RPM's as needed.

It is an object of the present invention for the generator to work and produce power, 110 volts or 220 volts that goes to a charging system that recharges the batteries.

It is an object of the present invention for an electric motor to be powered by a battery attached to an AC/DC converter. The motor turns the generator on. The power goes into the charging system to recharge the battery. The electric motor is a attached to a variable speed pulley. It is an object of the present invention for the electric motor to pivot a few degrees. When the generator wants more power, the variable speed pulley increases revolutions.

### BRIEF DESCRIPTION OF THE DRAWINGS

FIG. 1 shows a flow diagram showing the system of the present invention.

### DETAILED DESCRIPTION OF THE INVENTION

The present invention relates to a consolidated energy system generator. The system comprises an electrical motor, a battery, generator, charging system, and an AC/DC converter.

In an embodiment, the battery power travels into an AC/DC converter or inverter depending on the power requirements for the electric motor. The power converter or inverter produces 110 or 220 volts for the electric motor. The motor and generator are belt driven with a variable speed pulley.

In an embodiment, the electric motor is on a motor plate, which pivots up or down. Either a voltage sensor or small on-board computer is attached to a small micro-motor that drives the worm gear. The worm gear is attached to the motor plate to help pivot the motor plate up or down which helps control RPM's of the motor generator.

In an embodiment, the motor to has a variable speed pulley that assists in controlling RPM's as needed.

In an embodiment, the generator works and produces power, 110 volts or 220 volts that goes to a charging system that recharges the batteries.

In an embodiment, an electric motor is powered by a battery attached to an AC/DC converter. The motor turns the generator on. The power goes into the charging system to recharge the battery. The electric motor is attached to a variable speed pulley. The electric motor is able to pivot a few degrees. When the generator wants more power, the variable speed pulley increases revolutions.

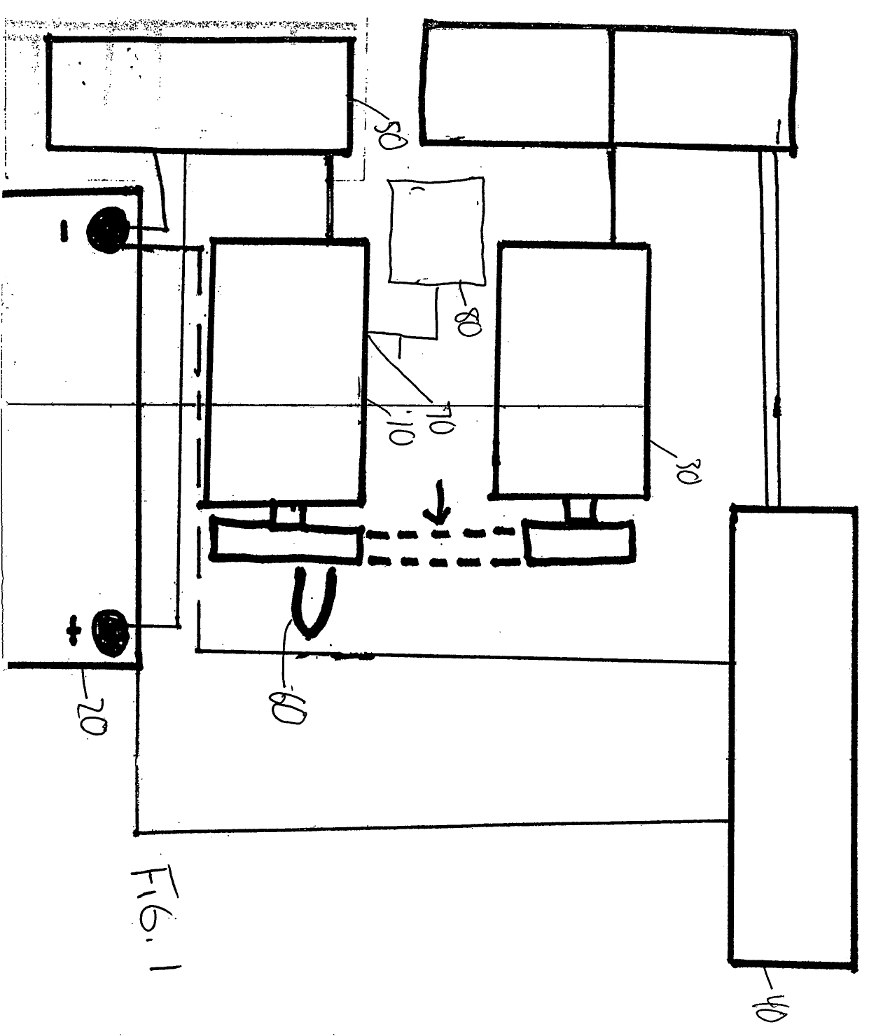

FIG. 1 shows the system of the present invention having a electrical motor 10, a battery 20, a generator 30, a charging system 40, and an AC/DC converter 50.

The power from the battery 20 travels into an AC/DC converter or inverter 50 depending on the power requirements for the electric motor 10. The power converter or inverter 50 produces 110 or 220 volts for the electric motor 10. The motor 10 and generator 30 are belt driven with a variable speed pulley 60.

The electric motor 10 is on a motor plate 70, which pivots up or down. Either a voltage sensor or small on-board computer 80 is attached to a small micro-motor that drives the worm gear. The worm gear is attached to the motor plate 70 to help pivot the motor plate 70 up or down which helps control RPM's of the motor generator 30.

In an embodiment, the motor 10 has a variable speed pulley 60 that assists in controlling RPM's as needed.

In an embodiment, the generator 30 works and produces power, 110 volts or 220 volts that goes to a charging system 40 that recharges the batteries 20.

In an embodiment, an electric motor 10 is powered by a battery 20 attached to an AC/DC converter 50. The motor 10 turns the generator 30 on. The power goes into the charging system 40 to recharge the battery 20. The electric motor 10 is attached to a variable speed pulley 60. The electric motor 10 is able to pivot a few degrees. When the generator 30 wants more power, the variable speed pulley increases revolutions or RPM.

1. A consolidated energy system generator comprising:
an electrical motor;
battery;
generator;
charging system; and
an AC/DC converter or inverter.

2. The system of claim 1 wherein power from said battery travels into said AC/DC converter or inverter depending on power requirements for said electric motor.

3. The system of claim 1 wherein said AC/DC converter or inverter produces 110 or 220 volts for said electric motor.

4. The system of claim 1 wherein said motor and generator are belt driven with a variable speed pulley.

5. The system of claim 1 wherein said electric motor is on a motor plate, which pivots up or down.

6. The system of claim 6 wherein a voltage sensor or small on-board computer is attached to a small micro-motor that drives a worm gear that is attached to said motor plate to help pivot said motor plate up or down to control RPM's of said motor generator.

7. The system of claim 1 wherein said motor has a variable speed pulley that assists in controlling RPM's as needed.

8. The system of claim 1 wherein said generator works and produces power, 110 volts or 220 volts that goes to said charging system that recharges said battery.

9. A consolidated energy system generator comprising:
an electric motor powered by a battery attached to an AC/DC converter;
said motor turns a generator on;
power goes into a charging system to recharge said battery;
said electric motor is attached to a variable speed pulley;
said electric motor pivots a few degrees;
said variable speed pulley increasing revolutions when said generator requires more power.
